(19) United States
(12) Patent Application Publication
(10) Pub. No.: US 2025/0356329 A1
(43) Pub. Date: Nov. 20, 2025

(54) SYSTEMS AND METHODS FOR MANAGING SECURE CARD ACCOUNT ACTIVITY

(71) Applicant: The PNC Financial Services Group, Inc., Pittsburgh, PA (US)

(72) Inventors: Rajesh Raman, Sewickley, PA (US); Ashley Renee Hall, Abington, PA (US); Meghan Schiffer, Pittsburgh, PA (US)

(73) Assignee: The PNC Financial Services Group, Inc., Pittsburgh, PA (US)

(21) Appl. No.: 18/949,511

(22) Filed: Nov. 15, 2024

Related U.S. Application Data
(60) Provisional application No. 63/648,005, filed on May 15, 2024.

(51) Int. Cl. G06Q 20/10; G06Q 20/24

(52) U.S. Cl. CPC G06Q 20/10; G06Q 20/24

(57) ABSTRACT

A system and method for making credit card to credit card payments. The system may include a processor, a network, a general ledger, a staging element with reconcilement capabilities, an institution account, and a clearing house account. The system may complete a credit card to credit card transaction by utilizing the credit available in a credit card account to reimburse funds utilized through the institution account. The clearing house ensures the transaction is satisfied by both the institution account and the credit card account. The operations may include providing an interface; using generative artificial intelligence to generate a prompt specific to an account associated with the interface; and displaying the prompt to a user of the account.

### CROSS-REFERENCE TO RELATED APPLICATION

This application claims the benefit of priority of United States Provisional Patent Application No. 63/648,005, filed on May 15, 2024, the entire contents of which are incorporated herein by reference.

### TECHNICAL FIELD

The disclosed embodiments relate to systems and methods for account payments, more particularly, making payments on a credit card account with another credit card account.

### BACKGROUND

Financial service providers are rapidly expanding the use of their services. Currently, most financial service providers provide mobile and digital banking services, which allow customers to perform basic functions and transactions remotely, for example, by using an application on a mobile device such as a cell phone or a tablet with an online web interface. Mobile and digital banking allows customers to manage their money. Customers may check account balances, pay bills, transfer funds, send money to others, deposit checks, receive customer support, apply for loans, receive alerts, apply for credit cards, manage benefits, manage credit/debit cards, review transactions, open new accounts, and perform many other banking services on a mobile or digital banking application on a mobile device or computer.

While these banking functions are useful for enabling funds to be electronically transferred, financial service providers have yet to allow customers to make secure payments from one credit card account to another credit card account. For example, online money transfer services may transfer funds from various accounts through a cash withdrawal between the accounts rather than a direct transfer between credit card accounts. Some online money transfer services may expose any linked cards to potential risk of fraud due to a lack of security regarding stored account information. Further, some online money transfer services present limitations, such as not allowing a user to review or cancel a transaction once initiated, which enhances the risk for fraudulent or unintentional transfers. As a result, what is needed is a system that allows users to make secure payments from one credit card account to another. In particular, what is needed is a banking service that allows users to safely and reliably transfer a portion of their credit in one credit card account to another credit card account. For example, what is needed is a system that allows a user to make a payment using a credit card account with no tangible funds associated with the account.

Further, what is needed is a solution for transferring money from one credit card account to another credit card account. More specifically, what is needed is a solution that allows a user to make a secure payment with a credit card account to another account by transferring funds managed by an institution such as a financial institution transferred to a recipient account through a clearinghouse.

### SUMMARY

The disclosed embodiments describe systems and methods for performing credit card to credit card transactions. For example, disclosed systems may include: a memory storing instructions, and at least one processor configured to execute the stored instructions to control: a general ledger, the general ledger configured to: receive a requested transaction from a first account, wherein the first account may be a credit account; receive transaction data associated with the first account and the requested transaction; and record the transaction data in the general ledger; a staging element configured to: receive the requested transaction from the general ledger; review the transaction data recorded in the general ledger; and validate the requested transaction based on the transaction data; an institution account configured to: receive the requested transaction from the staging element; and send funds from the institution account to a clearing house based on the requested transaction; and the clearing house configured to: receive the funds from the institution account; receive the transaction data; and transfer the funds received from the institution account to a second account. The processor may be further configured to: verify the funds received by the clearing house from the institution account satisfies an amount determined by the requested transaction; reduce a balance of the first account by the funds transferred from the institution account to the clearing house; raise a balance of the institution account by the funds transferred from the institution account to the clearing house; and raise a balance of the second account by the funds received from the clearing house.

According to some embodiments, the second account may be a credit account.

According to some embodiments, the staging element may be further configured to request verification data from a user of the first account.

According to some embodiments, the general ledger may be further configured to record the verification data.

According to some embodiments, the system may further comprise a real time clearing house configured to perform the same actions as the clearing house in real time.

According to some embodiments, the staging element may be further configured to determine whether the transaction data should be sent to the clearing house or the real time clearing house; and the institution account may be further configured to receive an indication from the staging element, the indication identifying whether the transaction data should be sent to the clearing house or the real time clearing house, and transfer funds from the institution account to either the clearing house or the real time clearing house based on the indication from the staging element and the transaction data.

According to some embodiments, the indication may comprise verification data.

According to some embodiments, the first account and the second account may be managed by the same user.

According to some embodiments, the first account and the second account may be managed by different users.

Disclosed embodiments may include a system comprising: a memory storing instructions; and at least one processor configured to execute the stored instructions to: access a platform that enables payment initiation; generate an interface for display on the platform that enables the payment initiation; analyze, through generative artificial intelligence, a balance limit for an account, an available balance for the account, and user information corresponding to a user associated with the account; generate a prompt, through generative artificial intelligence, for display on the interface based on the balance limit, the available balance, and the user information, the prompt providing options for managing the account; wherein the options are specific to a user; and present the prompt on the interface.

According to some embodiments, the prompt may inform the user associated with the account of a potentially fraudulent transaction based on the user information.

According to some embodiments, the prompt may further inform the user of actions to take in response to the potentially fraudulent transaction based on the user information.

According to some embodiments, the prompt may inform the user of an option to request a transaction from a second account, wherein the transaction increases the available balance of the account and reduces an available balance of the second account.

According to some embodiments, the user may manage the second account.

According to some embodiments, the prompt may further comprise a notification in the second account regarding a request to complete a transaction from the first account.

According to some embodiments, the prompt may inform the user to complete a transaction to a second account, wherein the transaction reduces the available balance of the first account and increases an available balance of the second account.

Disclosed embodiments may include a method comprising: receiving a request from a user to make a transaction from a first account to a second account, wherein the first account may be a credit account; sending the request and transaction data to a ledger, wherein the ledger records the transaction data; sending the request from the ledger to a staging element, wherein the staging element reviews the transaction data recorded in the ledger to validate the requested transaction; sending the request from the staging element to an institution account, wherein the institution account retrieves funds based on the requested transaction; sending the transaction information and retrieved funds from the institution account to a clearing house; determining, through the staging element, that the transaction data is cleared; and transferring the retrieved funds from the clearing house to the second account.

According to some embodiments, the staging element may determine that the transaction data is not cleared, and the retrieved funds are returned to the institution account.

According to some embodiments, the second account may be a credit account.

According to some embodiments, the clearing house may clear the transaction in real time.

It is to be understood that both the foregoing general description and the following detailed description are exemplary only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1a is an exemplary embodiment of a user's desire to make payments on one credit card account from another credit card account.

FIG. 1b is an exemplary embodiment of a user's satisfaction with a payment system that allows credit card payments to be made by other credit cards.

FIG. 2a is a block diagram of an exemplary system environment, consistent with disclosed embodiments;

FIG. 2b is an exemplary schematic diagram of a system environment, consistent with disclosed embodiments.

FIG. 3 illustrates an exemplary graphical user interface (GUI) for an account low on funds being prompted to request a transfer.

FIG. 4 illustrates an exemplary GUI for an account that has been requested to transfer funds to another account managed by the same user.

FIG. 5 illustrates an exemplary GUI for an account with sufficient funds being suggested to transfer funds to another account.

FIG. 6 is an exemplary flow chart of a credit card to credit card payment process, consistent with some disclosed embodiments.

### DETAILED DESCRIPTION

Reference will now be made in detail to exemplary embodiments, discussed with reference to the accompanying drawings. In some instances, the same reference numbers will be used throughout the drawings and the following description to refer to the same or like parts. Unless otherwise stated, technical and/or scientific terms have the meaning commonly have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limited.

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

Reference will now be made in detail to the disclosed embodiments, examples of which are illustrated in the accompanying drawings.

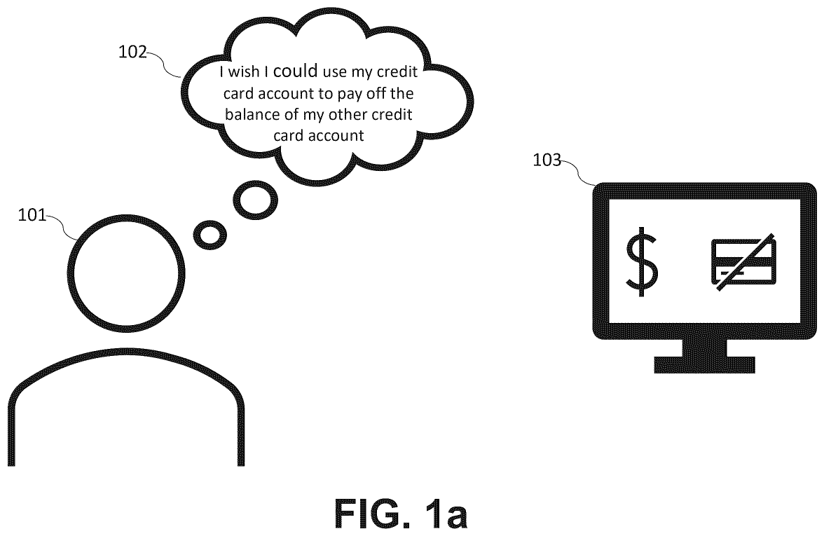

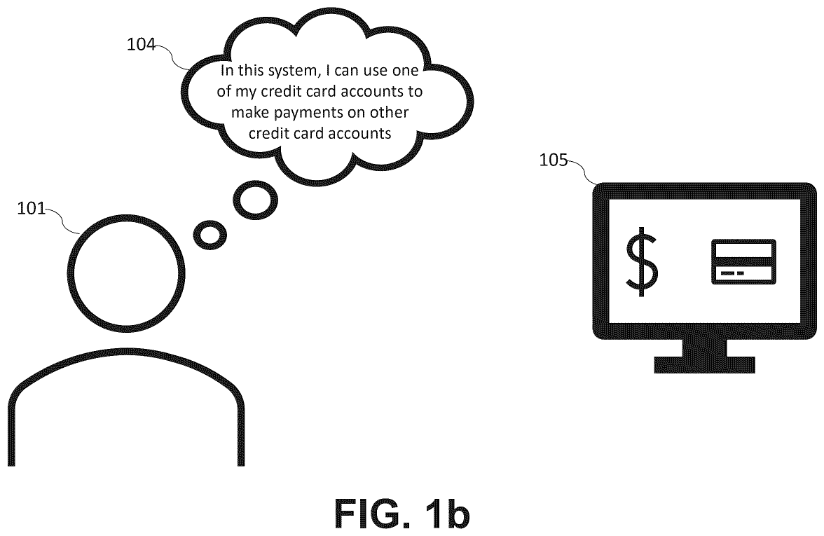

FIG. 1a illustrates an exemplary embodiment of a user 101 expressing a desire 102 to make payments from one credit card account to another. In some embodiments, user 101 may be an individual. In other embodiments, user 101 may be an organization or entity. FIG. 1a also illustrates a web-based application 103. Web-based application 103 may be any application capable of connecting to a server and enabling payment initialization. For example, web-based application may be a mobile device application or internet webpage. As illustrated in Fig. la, web-based application 103 does not permit credit card to credit card payments. Thus, user 101 does not have the flexibility to make credit card payments using another credit card account despite having an available balance on that credit card account.

FIG. 1b illustrates an exemplary embodiment of user 101, as described with respect to FIG. 1a, expressing a satisfied thought 104 based on a web-based application 105 permitting a credit card to credit card payment. This allows user 101 to make a payment with a credit card without the need to have any funds available in a debit account.

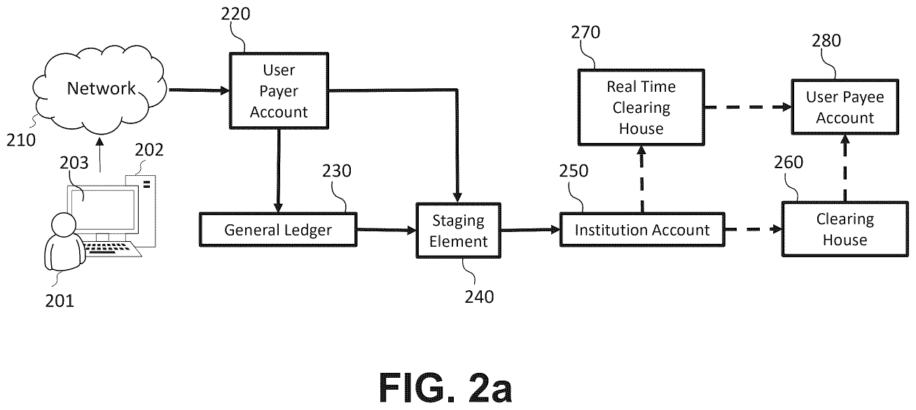

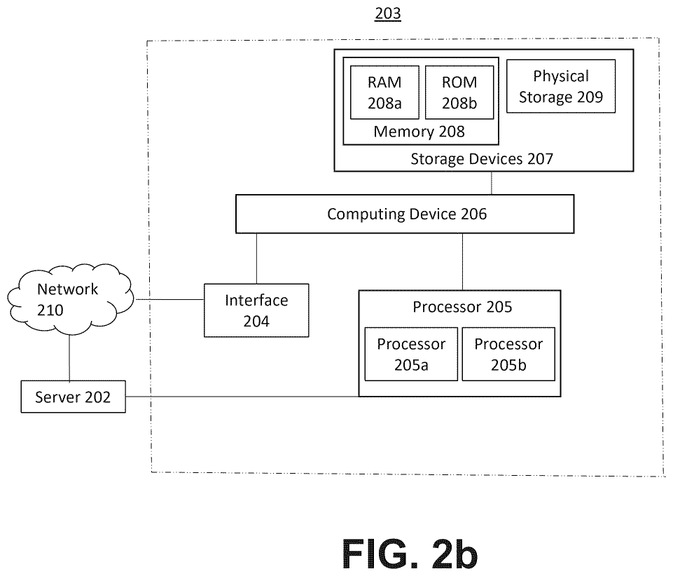

FIG. 2a illustrates an exemplary credit card to credit card payment system, consistent with disclosed embodiments. A user 201 may attempt to make a payment from one credit card account to another credit card account on a server 202 through an end point device 203. User 201 may be any credit card holder or authorized user of a credit card. In some embodiments, end point device 203 may be a personal computer (e.g., a desktop or laptop computer), a mobile device (e.g., a mobile phone or tablet), a wearable device (e.g., a smart watch, smart jewelry, implantable device, fitness tracker, smart clothing, head-mounted display, etc.), an IoT device (e.g., smart home devices, industrial devices, etc.) or any other device that may be capable of accessing web pages or other network locations.

This attempted payment may be transmitted to a network 210 which may maintain and provide a database of information. The information stored in the database may, for example, include information regarding user 201, a user payer account 220, and a user payee account 280. User payee account 280 may refer to a financial account such as a credit or checking account. User payer account 220 and user payee account 280 may be managed by the same user or, alternatively, may be managed by different users. The database may also include information such as other accounts managed by user 201, the balances and funds on all the accounts managed by user 201, and any upcoming transactions involving user 201 such as deposits, withdrawals, and payments. The database may also store information corresponding to other users that may have accounts associated with network 210. Network 210 may, for example, be a privileged network that requires authorization to access. For example, only authorized devices may access the data stored in network 210. An authorized device may be a device with administrative credentials (e.g., a username and password, multi factor authentication, etc.) or a device connected to a virtual private network (VPN). For example, network 210 may be a financial institution network, and access to network 210 may be restricted to those with proper credentials. A financial institution network may be any network (such as network 210) managed by a financial institution such as a bank or creditor.

User 201 may access network 210 through server 202 and end point device 203 in order to complete a transaction. Server 202 may include any form of remote computing and may be configured to store files accessible through network 210 (e.g., a web server, application server, virtualized server, etc.). A transaction may be a monetary transaction such as a payment from one credit card account to another credit card account. For example, user 201 may input information regarding a credit card account to make a payment from and a credit card account to pay a balance on through end point device 203. Such information may include an account number associated with the credit card accounts, a social security number associated with the credit card accounts, a username and password, or any other information that would allow user 201 to access the credit card accounts.

Network 210 may then associate the requested transaction with user payer account 220. User payer account 220 may be any credit card account. User payer account 220 may be associated with a checking account or other financial account with accessible funds. User payer account 220 may alternatively be a credit card account without access to any tangible funds. The requested transaction sent by user 201 may indicate a credit amount to be sent from user payer account 220 to a general ledger 230. General ledger 230 may be any form of recordation of financial transactions associated with an institution. The record maintained in general ledger 230 may be used to ensure transactions through an institution are valid and accurate. For example, user 201 may request a transaction that transfers some portion of a credit line from user payer account 220 to some other account. User 201 may input a quantity associated with user payer account 220 to be transferred such as a dollar amount, or user 201 may indicate some threshold to satisfy such as a minimum payment required by the other account. General ledger 230 may record the requested transaction and corresponding data associated with the requested transaction. The record created by general ledger 230 may be reviewed prior to fulfillment of the requested transaction to validate the amount of the transfer to ensure user payer account 220 has a sufficient balance to satisfy the requested transaction. For example, general ledger 230 may have recorded information of other payments corresponding to user payer account 220, such as pending transactions. Review of general ledger 230 may indicate that fulfilling such pending transactions and completing the requested transaction may lead to a negative balance available in user payer account 220, and the requested transaction may then be denied.

The requested transaction may then be sent to a staging element 240 to prepare the requested transaction. Staging element 240 may include a computing device (similar to computing device 206 described in FIG. 2b) and may be designed to fulfill requested transactions. More specifically, staging element 240 may be a system including a processor, database, and computing device, consistent with disclosed embodiments. Staging element 240 may be connected to and interact with several different accounts such as user payer account 220, institution account 250, and user payee account 280 in addition to general ledger 230 to ensure communication between all accounts are secure and valid. Staging element 240 may review the information recorded in general ledger 230 and may provide additional security in the requested transaction by seeking validation. Such validation may include, for example, providing a notification to user 201 requesting that user 201 validate the transaction. Once staging element 230 validates the requested transaction, then the requested transaction may be processed through a clearing house. For example, staging element 240 may be connected to user payer account 220, general ledger 230, an institution account 250, and a clearing house 260 or a real time clearing house 270. Institution account 250 may refer to a holding account with funds managed by an institution (such as a financial institution), which can be used to make a payment into a credit card account. Clearing house 260 and real time clearing house 270 may, for example, be holding accounts managed by a different financial institution than the institution that manages institution account 250 and may act as a third party to the requested transaction to ensure the requested transaction between user payer account 220 and user payee account 280 is accurate and fulfilled, and to ensure that user payer account 220 has provided sufficient funds to institution account 250. Thus, clearing house 260 and real time clearing house 270 may act as a neutral buffer to avoid any conflicts to the fulfillment of the requested transaction to reduce the risk of erroneous or fraudulent transactions taking place.

Staging element 240 may review general ledger 230 to determine the requested transaction, including retrieving information such as user payer account 220, the amount to transfer in the requested transaction, and the intended account for the requested transaction. Staging element 240 may then retrieve the necessary funds from user payer account 220 to cover the requested transaction (either in tangible funds or available credit depending on whether user payer account 220 is linked to a credit account) according to the information retrieved from general ledger 230 to send such funds to institution account 250 (wherein the institution account 250 acts as a holding account to the requested transaction). If the credit is sufficient to cover the requested transaction and the requested transaction may be validated, staging element 240 may send the credit and the requested transaction to institution account 250.

For example, if user payer account 220 is linked to a checking account or other financial account with accessible funds, staging element 240 may review general ledger 230 to determine the amount of accessible funds available in that checking account or other financial account with accessible funds to determine if the amount of accessible funds exceeds the amount of credit in the requested transaction. If the amount of accessible funds exceeds the amount of credit in the requested transaction, staging element 240 may validate the requested transaction and process the requested transaction by sending the funds associated with the requested transaction from user payer account 220 to institution account 250. For example, staging element 240 may transfer funds from user payer account 220 to another account by the amount of funds requested to be transferred in the requested transaction. Staging element 240 may also update the recorded data in general ledger 230 to reflect the validated requested transfer so that the requested transaction is recorded as completed rather than pending.

Alternatively, if user payer account 220 is not linked to any account with accessible funds and is instead simply a credit account, staging element 240 may review general ledger 230 to determine other transactions associated with user payer account 220 and calculate an available balance associated with user payer account 220 to determine whether user payer account 220 has the available credit balance to complete the requested transaction. If staging element 240 reviews the transactions associated with user payer account 220 and determines that user payer account 220 has the available credit balance to complete the requested transaction (i.e., the recorded transactions in general ledger 230 indicate that user payer account 220 has an available credit balance that exceeds the amount of credit sought to be transferred in the requested transaction), staging element 240 may transfer an available credit balance amount from user payer account 220 to another account by the amount of credit requested to be transferred in the requested transaction. Staging element 240 may also update the recorded data in general ledger 230 to reflect the validated requested transfer so that the requested transaction is recorded as completed rather than pending.

If user payer account 220 does not have sufficient funds to cover the requested transaction, staging element 240 may deny the requested transaction. For example, staging element 240 may determine that the requested transaction cannot be completed by reviewing general ledger 230 and finding no corresponding recordation of the requested transaction or determining that the requested transaction would result in a negative balance in user payer account 220. If the requested transaction is denied, staging element 240 may update the recoded data in general ledger 230 to reflect that the requested transaction was not completed. Staging element 240 may also return a notification to user 201 through an interface on end point device 203 that the transaction was denied and the notification may inform user 201 of the reason for denial. For example, the notification may indicate to user 201 that user payer account 220 did not have the requisite funds to complete the transaction. The notification may also provide suggestions to user 201 to resolve the denial and to request the transaction again. For example, the notification may suggest that user 201 pay off an existing balance on user payer account 220 and attempt the transaction again by selecting feature on the interface on end point device 203. More specifically, staging element 240 may alter the interface displayed on end point device 203 to provide an indication to user 201 regarding suggested options (i.e., an arrow pointing to a specific feature such as a feature for user 201 to make a payment on user payer account 220 or highlighting an input box for user 201 to reenter input information regarding the requested transaction).

Alternatively, staging element 240 may return an error if the necessary information is not available in general ledger 230 or if the requested transaction cannot be completed. For example, user 201 may have incorrectly entered information on the requested transaction such as providing an invalid account number, so staging element 240, upon review of general ledger 230, may determine that the requested transaction cannot be completed. Staging element 240 may then return an error notification to user 201 through an interface on end point device 203, which may indicate that the transaction cannot be completed. The notification may also inform user 201 of the source of the error and provide suggestions on how to correct the error. For example, the notification may inform user 201 that the account information appears incorrect and may suggest that user 201 reenter the information and request the transaction again. More specifically, staging element 240 may alter the interface displayed on end point device 203 to indicate what information user 201 entered that resulted in the returned error (i.e., a prompt requesting that user 201 reenter the account number).

Consistent with the present disclosure, disclosed embodiments may involve a network (e.g., 210). A network (e.g., 210) may constitute any type of physical or wireless computer networking arrangement used to exchange data between, for example, end point device 203, server 202, and/or a memory. For example, a network (e.g., 210) may be the Internet, a private data network, a virtual private network using a public network, a Wi-Fi network, a LAN or WAN network, a combination of one or more of the foregoing, and/or other suitable connections that may enable information exchange among various components of the system. In some embodiments, a network (e.g., 210) may include one or more physical links used to exchange data, such as Ethernet, coaxial cables, twisted pair cables, fiber optics, or any other suitable physical medium for exchanging data. A network (e.g., 210) may also include a public switched telephone network (“PSTN”) and/or a wireless cellular network. A network (e.g., 210) may be a secured network or unsecured network. In other embodiments, one or more components of the system may communicate directly through a dedicated communication network. Direct communications may use any suitable technologies, including, for example, BLUETOOTH™, BLUETOOTH LE™ (BLE), Wi-Fi, near field communications (NFC), or other suitable communication methods that provide a medium for exchanging data and/or information between for example, endpoint device 203, server 202, and/or a memory.

The requested transaction may be completed in real time. In some embodiments, real time may refer to transactions that are completed in less than an hour (i.e., within seconds or minutes). Institution account 250 may send funds equivalent to the requested transaction to either clearing house 260 or real time clearing house 270. Clearing house 260 and real time clearing house 270 provide user 201 with time to review the requested transaction, including reviewing the amount, origin, and intended destination of the requested transaction, prior to the transfer of funds, and thus allows user 201 to combat any potential fraudulent or inaccurate transactions.

For example, while the funds are held in clearing house 260, user 201 may receive a notification through an interface on end point device 203 that a transaction involving user payer account 220 has been attempted and is pending for a period of time. User 201 may then use the period of time that the requested transaction is pending to review the requested transaction and ensure user 201 wants to complete the requested transaction. If the requested transaction is fraudulent, user 201 may notify the institution that manages user payer account 220 to prevent the requested transaction from being processed. Alternatively, while the funds are held in real time clearing house 270, user 201 may receive a notification through an interface on end point device 203 that requests user 201 confirm the requested transaction, that the requested transaction will remain pending until such verification is received from user 201, and that the requested transaction will be denied if user 201 does not validate the transaction within a specified period of time. This ensures that user 201 validates the requested transaction before any funds may be transferred from user payer account 220. If the requested transaction is fraudulent, user 201 may refuse to validate the requested transaction either by not responding to the notification or by notifying the institution that manages user payer account 220. If user 201 identifies the requested transaction as fraudulent, clearing house 260 and real time clearing house 270 may return the funds received from institution account 260 rather than send the funds to user payee account 280.

Real time clearing house 270 may be similar to clearing house 260, but real time clearing house 270 may have real time capabilities to complete the requested transaction. For example, clearing house 260 may require several hours or days in order to complete the requested transaction to ensure the validity of the requested transaction. Real time clearing house 270 may be able to verify and fulfill the requested transaction within a matter of minutes. User 201 may request, through an interface on end point device 203, that a requested transaction be processed through real time clearing house 270 or, alternatively, the institution that manages institution account 250 may determine whether the requested transaction should be processed through clearing house 260 or real time clearing house 270.

Alternatively, staging element 240 may determine whether the requested transaction may be processed through real time clearing house 270. For example, staging element 240 may be capable of sending a notification to user 201 that requests user 201 validate the requested transaction. User 201 may receive the notification that the requested transaction is being completed and may request that user 201 verify the transaction for rapid payment. If user 201 verifies the requested transaction, staging element 240 may receive the verification and transmit the verification to the institution account 250. This verification may act as an indication that the transaction does not need to be stored in a holding account, so institution account 250 may send the requested transaction and corresponding funds from user payer account 220 to real time clearing house 270 rather than clearing house 260. Once real time clearing house 270 receives the requested transaction, corresponding funds, and verification, real time clearing house 270 may process and fulfill the requested transaction within minutes. Staging element 240 may then also update the recorded data in general ledger 230 to reflect that the requested transaction has been validated and completed.

If user 201 does not verify the requested transaction, staging element 240 may send the requested transaction and corresponding data to institution account 250, and institution account 250 may send the requested transaction and corresponding funds to clearing house 260. Once clearing house 260 receives the requested transaction and corresponding funds, clearing house 260 may hold the requested funds as “pending” for a period of time. At the end of the period of time, clearing house 260 may process and fulfill the requested transaction. Alternatively, if use 201 does not verify the requested transaction, staging element 240 may deny the requested transaction and transmit a notification to user 201 through an interface on end point device 203 that the requested transaction has been declined based on the lack of verification. Staging element 240 may also update the recorded information in general ledger 230 to reflect that the transaction has not been validated and has been denied.

Clearing house 260 and real time clearing house 270 may ensure that the funds received from institution account 250 are sufficient to cover the requested transaction, that the requested transaction was an intended transaction by user 201, and that institution account 250 is adequately compensated by user payer account 220 for the requested transaction. For example, clearing house 260 may hold the funds transferred from institution account 250 for a set period of time to allow user 201 to review the requested transaction before funds are transferred from user payer account 220 to institution account 250. During this time, clearing house 260 may identify the requested transaction as “pending.” Alternatively, real time clearing house 270 may hold the funds transferred from institution account 250 until user 201 validates the requested transaction. For example, user 201 may receive a notification with details regarding the requested transaction such as the quantity of funds to transfer in the requested transaction and the recipient account number. In some embodiments, the notification may request that user 201 verify the information. Real time clearing house 270 may identify the requested transaction as “pending.”

Upon sufficient verification, clearing house 260 or real time clearing house 270 (depending on which account institution account 250 sends the funds to) may transfer funds to user payee account 280 from institution account 250, according to the requested transaction.

FIG. 2b illustrates an exemplary schematic diagram of end point device 203. According to FIG. 2b, end point device 203 may contain an interface 204 that may be connected to network 210, which may enable communication between a user and a server 202, a computing device 206, one or more processors 205 (illustrated as processors 205a and 205b) communicatively coupled with computing device 206 for processing information communication and a storage devices 207 for storing instructions associated with one or more processors 205. Consistent with disclosed embodiments, computing device 206 may be configured to receive, transform, and transmit data. For example, computing device 206 may receive a request from network 210 through interface 204 to access information associated with a user. Computing device 206 may access storage devices 207 to retrieve the requested information based on the request from network 210, and display results on end point device 203 through interface 204.

Computing device 206 may receive the inputs from user 201 through interface 204, access network 210 to determine the corresponding account information linked to user payer account 220 and any other accounts as determined by the inputs of user 201, and perform the requested transaction according the instructions stored in storage devices 207.

Consistent with disclosed embodiments, a processor, as discussed herein, may constitute any physical device or group of devices having electric circuitry that performs a logical operation on an input or inputs. For example, a processor may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logical operations. In some embodiments, processor may include more than one processor. For example, in FIG. 2b, processor 205 has includes two processors 205a and 205b. Each processor (i.e., processors 205a and 205b) may have a similar construction or each processor may be of differing constructions that are electrically connected or disconnected from each other. For example, processors 205a and 205b may be separate circuits or integrated in a single circuit. When more than one processor is used, the processors may be configured to operate independently or collaboratively, and may be co-located or located remotely from each other. Processors 205a and 205b may be coupled electronically, magnetically, optically, acoustically, mechanically, or by other means that permit them to interact.

The instructions executed by processor 205 may, for example, be pre-loaded into storage devices 207. Storage devices 207 may include, for example, a memory 208 and a physical storage 209. Memory 208 may include a Random Access Memory (RAM 208a) which and a Read-Only Memory (ROM 208b). Physical storage 209 may include, for example, a hard disk, an optical disk, a magnetic medium, a flash memory, other permanent, fixed, or volatile memory, or any other mechanism capable of storing instructions. As used herein, a memory refers to any type of physical memory on which information or data readable by at least one processor may be stored. Examples of memory include RAM 208a, ROM 208b, volatile memory, nonvolatile memory, hard drives, CD ROMS, DVDs, flash drives, any other optical data storage medium, any physical medium with patterns of holes, markers, or other readable elements, a PROM, an EPROM, a FLASH-EPROM or any other flash memory, NVRAM, a cache, a register, any other memory chips or cartridge, and networked versions of the same.

The terms “memory” and “computer-readable storage medium” may refer to multiple structures, such as a plurality of memories or computer-readable storage mediums located within an input unit or at a remote location. Additionally, one or more computer-readable storage mediums may be utilized in implementing a computer-implemented method. The memory may include one or more separate storage devices collocated or disbursed, capable of storing data structures, instructions, or any other data. The memory may further include a memory portion containing instructions for the processor to execute. The memory may also be used as a working scratch pad for the processors or as a temporary storage. Accordingly, the term computer-readable storage medium should be understood to include tangible items and exclude carrier waves and transient signals.

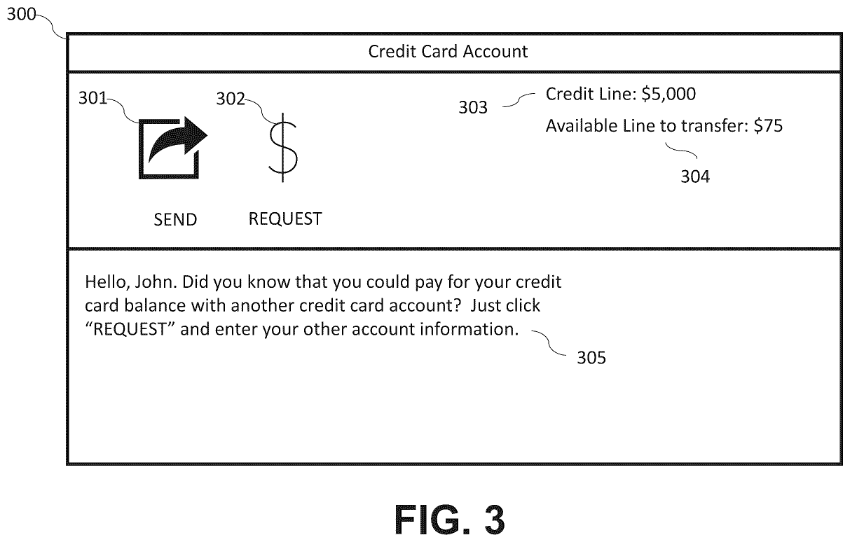

FIG. 3 illustrates an exemplary graphical user interface (GUI) 300 that enables credit card to credit card payments. GUI 300 may appear on end point device 203 as described in FIG. 2a through interface 204 as described in FIG. 2b for user 201 to interact with. As shown in FIG. 3, GUI 300 may include a send button 301, a request button 302, a credit line 303 and an available line to transfer 304. When selected, send button 301 may allow a user to transfer funds from the account they are currently interacting with to another account. Thus, for example, when a user selects send button 301, GUI 300 may prompt the user to input information regarding sending funds to another account. This may include a prompt to receive inputs for an intended recipient of the funds, a quantity of funds to transfer, an option to make repeated transfers at some predetermined time limit, and an option to automatically transfer funds to the intended recipient if the intended recipient account balance falls below a threshold. The user may manage both the first account and the second account or, alternatively, the user may manage only the first account.

Upon selection of send button 301 and entering of the corresponding requested information, the transaction may be completed, consistent with disclosed embodiments. The user may select send button 301 and input the corresponding requested information into an end point device. The user may then receive a notification regarding the requested transaction, and the user may verify the requested transaction. The system as described with respect to disclosed embodiments may deduct funds from the user's account and send to those funds to an institution account consistent with disclosed embodiments. The institution account may send the funds to a real time clearing house, and the real time clearing house may send the funds to a second account to complete the requested transaction, consistent with disclosed embodiments.

Request button 302 may allow the user to request that funds from another account be transferred to the account the user is currently interacting with. Thus, for example, when a user selects request button 302, GUI 300 may prompt the user to input information regarding another account for the system to request funds be sent from. Selecting request button 302 may include generating prompt to receive inputs for an intended account to send the funds, a quantity of funds to request, an option to notify a user that manages the intended account, a text box that allows the user requesting the funds to describe a purpose for the request, and an option to request an automatic transfer of funds to the user if the user's account balance falls below a threshold.

Credit line 303 may refer to a limit of funds the user can borrow with their account. Available line to transfer 304 may refer to how much the user can still borrow to their credit card account. Thus, for example, staging element 240 of FIG. 2a may compare a value of a requested transaction to available line to transfer 304 from FIG. 3. If the value of the requested transaction is less than available line to transfer 304, then the payment can be made.

GUI 300 may also display a prompt 305. Prompt 305 may be created by generative artificial intelligence (AI) and may be specific to the user. Prompt 305 may result from the generative AI analyzing credit line 303, available line to transfer 304, and information regarding the user such as whether the user has other accounts and whether the user has made credit card to credit card payments with any other accounts. Accordingly, credit line 303 and available line to transfer 304 may indicate that the user may need to complete a payment transaction on their account. Thus, the generative AI may generate prompt 305 suggesting that user select request button 302. Prompt 305 may inform the user of the option to request funds from another account to ensure the user does not incur any charges or defaults on their account.

For example, the generative AI may receive information that a user manages two separate accounts. This may include information that demonstrates that a first of the user's accounts has available line to transfer 304 that is less than credit line 303 and a second of the user's accounts has available line to transfer 304 that is equal to credit line 303. The information may further include an indication that the first of the user's accounts has an upcoming balance due and the second of the user's accounts does not have an upcoming balance due. The generative AI may then determine that the user of the first account may benefit from a notification to select request button 302. Therefore, when the user logs on to the first account, the generative AI may generate prompt 305 to inform the user that the first account has a balance due. Prompt 305 may also inform the user that the user may request a payment on the first account from the second account utilizing available line to transfer 304 from the second account. Further, the generative AI may suggest that the user request money from the second account or a different account based on the generative AI's review of prior transactions and account information for those accounts (i.e., whether the other account currently has no balance due, whether the other account always makes full payments on time, whether the first account has made a prior successful request from that other account, etc.)

The generative AI may also alter its presentation to the user based on information gathered regarding how the user responds to various prompts. For example, the generative AI may store information relating to how often a user interacts with a GUI in a database consistent with disclosed embodiments based on the suggestions of different prompts, including prompts with visuals, prompts in different fonts, and prompts that require interaction to advance to other features on the GUI. The generative AI may also alter the location of the prompt. For example, the generative AI may place the prompt in an unused portion of the GUI or, alternatively, the generative AI may place the prompt over other fields in the GUI based on the user's prior interactions with the prompts and the importance of the prompt.

GUI 300 may display icons, for example, a plurality of icons. An icon may be a pictogram or ideogram displayed on a graphical user interface and may help a user navigate the graphical user interface. An icon may be a quickly comprehensible symbol of a data file, software tool, or function, accessible by a processor. An icon may serve as an electronic hyperlink or file shortcut to access data. A user may activate an icon using, for example, a mouse, pointer, finger, or voice command, among other options. An icon's placement on the graphical user interface may provide further information about the icon's usage or associations with relevant data. In activating an icon, a user may move directly into and out of the identified data or function without knowing anything further about the location or requirements of the data file or code. The plurality of icons may be generated by a processor by accessing data stored in a directory of data stored in a memory.

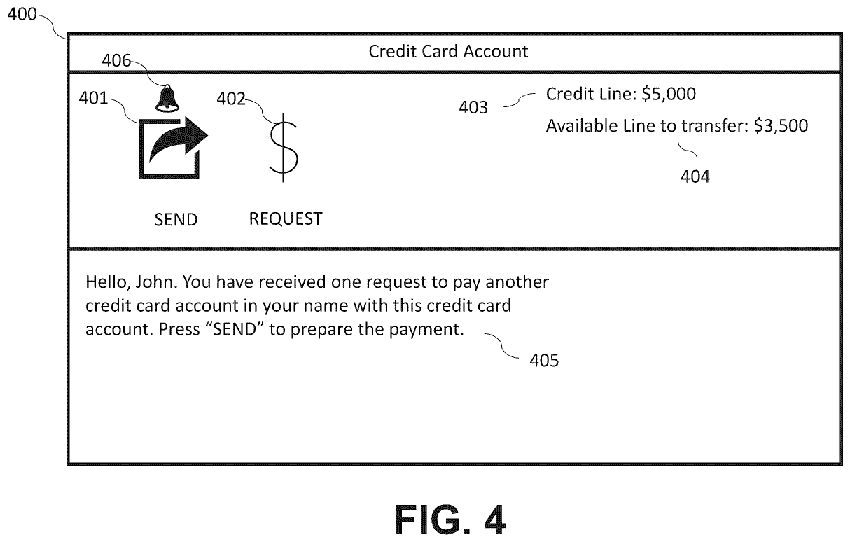

FIG. 4 illustrates an exemplary GUI 400. GUI 400 may appear on end point device consistent with disclosed embodiments. In GUI 400, a user can see a send button 401, a request button 402, a credit line 403 and an available line to transfer 404, similar to that of GUI 300 in FIG. 3. For example, credit line 403 may refer to a limit of funds the user can borrow with their account. Available line to transfer 404 may refer to how much the user can still borrow to their credit card account. However, GUI 400 has a prompt 405, which may be different from prompt 305. Prompt 405 may inform the user that they may send funds from their account to another account as opposed to prompt 305, which informs the user that they may request funds from another account. Further, GUI 400 may incorporate generative AI consistent with disclosed embodiments. The generative AI may receive information to determine that credit line 403 and available line to transfer 404 indicate that the account is not in need of making a payment. Further GUI 400 displays a notification 406. Notification 406 may appear when another account has sent or requested funds for a credit card to credit card transaction. In GUI 400, prompt 405 may explain that notification 406 appeared because another account requested funds from this account. Further, prompt 405 may explain that the other account may be managed by the same user as the account displayed in GUI 400. The generative AI as described in FIG. 4 may be used in a similar fashion as to how it was described with respect to FIG. 3. For example, a user who receives a request from another account through request button 302 or request button 402 may then receive notification 406 on GUI 400. The user may interact with notification 406 by, for example, using a mouse and hovering over notification 406 or clicking notification 406, or, using a touchscreen device, tapping notification 406. If the user interacts with notification 406, GUI 400 may produce a display similar to the display provided by selecting send button 301 consistent with disclosed embodiments. By selecting notification 406, the user may see information corresponding to the request created by the user that selected request button 402. Thus, the user may not need to enter any information related to the requested transaction because the user that selected request button 402 may have already input that information. For example, by selecting notification 406, the user may not need to enter inputs such as an intended account to send the funds or a quantity of funds to request. Further, the user may be able to review a text box filled out by the user that selected request button 402 for additional information regarding the request. The user may then review the information, make any edits such as altering the quantity of funds to transfer and complete the requested transaction. Alternatively, the user may decline the requested transaction. A user who decides to complete the requested transaction goes through the process consistent with disclosed embodiments illustrated in FIG. 2a.

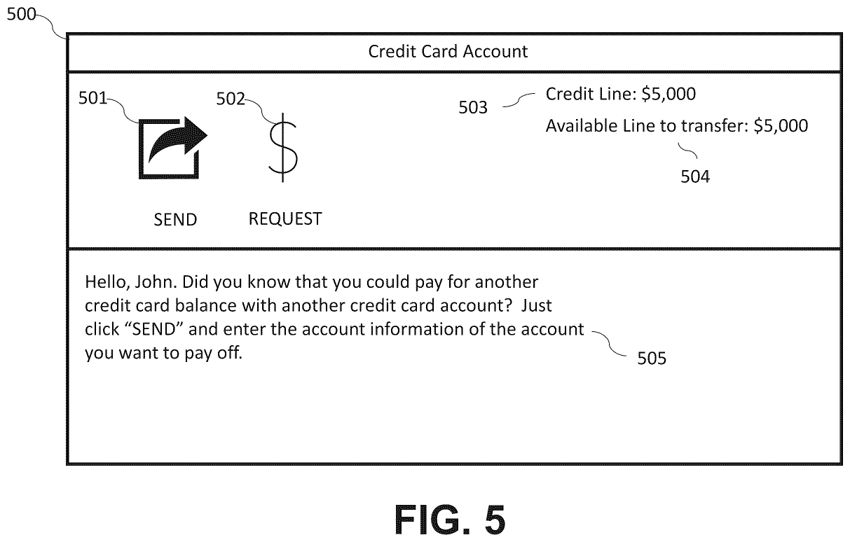

FIG. 5 illustrates an exemplary GUI 500. GUI 500 may appear on the end point consistent with disclosed embodiments. Similar to GUI 300 and GUI 400, from FIGS. 3-4 respectively, GUI 500 may display a send button 501, a request button 502, a credit line 503 and an available line to transfer 504 For example, credit line 503 may refer to a limit of funds the user can borrow with their account. Available line to transfer 504 may refer to how much the user can still borrow to their credit card account. Credit line 503 and available line to transfer 504 may indicate that an account has full availability of credit. As a result, GUI 500 may utilize generative AI. consistent with disclosed embodiments. In some embodiments, prompt 505 may inform a user about their ability to use their account to pay off other accounts.

Unlike GUI 400 in FIG. 4, GUI 500 in FIG. 5 does not have a notification regarding a request from another account. Thus, the generative AI in GUI 500 may generate a prompt that may account for other information regarding the user. For example, prompt 505 may highlight another account managed by the user or, alternatively, an account not managed by the user, yet associated with the user, (i.e., a family member's account, a joint account, etc.) that is in need of funds. Alternatively, the generative AI may review planned or upcoming transactions that involve the account and other accounts affiliated with the user and generate prompt 505, which may inform the user of such upcoming payments and suggest that the user make payments using their account according to GUI 500.

FIGS. 3-5 merely demonstrate examples of situations where generative AI prompts may appear on a user's account. The generative AI may produce a prompt in situations where both accounts have some outstanding balance. Additionally, the generative AI may produce a prompt when one account is managed by one institution and the other account is managed by a different institution. Such a prompt may, for example, be a text prompt informing the user of their available options regarding transferring funds between the two institutions, any associated fees, and the potential for fraud. More specifically, the generative AI may evaluate the various payment options available to the user and suggest payment options based on cost, speed, and ease to the user. For example, the generative AI may generate a prompt informing a user that an upcoming payment is due for an account at a different financial institution, and that the user can make a payment directly on their account or, alternatively, that the user can make a payment from the account with the generative AI for a small fee by pressing a send button consistent with disclosed embodiments. In such situations, however, the generative AI may require additional inputs from the user to associate the user with various accounts. For example, the generative AI may require a user to input information regarding the user's identity and other accounts that the user wants associated with their account. Providing the generative AI with greater access to information regarding the user allows the generative AI to construct more specific prompts to the user and also construct prompts more directly aimed at preventing fraud. For example, the user may be required, by the generative AI, to input accounts that the user wants linked to their account. The generative AI may then review the intended target for all attempted transactions to reduce the risk of fraud. For example, if a transaction sends funds from a user's account to an unrecognized account, the generative AI may construct a prompt that appears while the transaction is pending, requesting that the user review the transaction. Further, if the information entered for the recipient is close to information that the user previously linked to their account (i.e., a user's input is off by one digit or letter on a keyboard for a recipient account previously linked to the user's account), the generative AI may construct a prompt that asks the user if they intended to send the funds to the account they previously provided before completing the transaction. Alternatively, the generative AI may receive access to a database such as a storage devices, which may contain information about all accounts associated with a user. Such storage devices may be, for example, a database consistent with disclosures according to FIG. 2b. A user may be able to add or remove accounts for the generative AI to associate with the user. For example, a user may link several accounts together such that the generative AI may evaluate the information associated with all linked accounts and generate prompts on one or more of the user's linked accounts.

The generative AI account may also utilize machine learning as an alternative to requiring account information from a user. For example, if a user tends to request payments from another account, the generative AI may be programmed to recognize that the payments are requested from a credit card account and generate a prompt in future instances to remind a user that a payment is upcoming and that they can request a payment from a different credit card account.

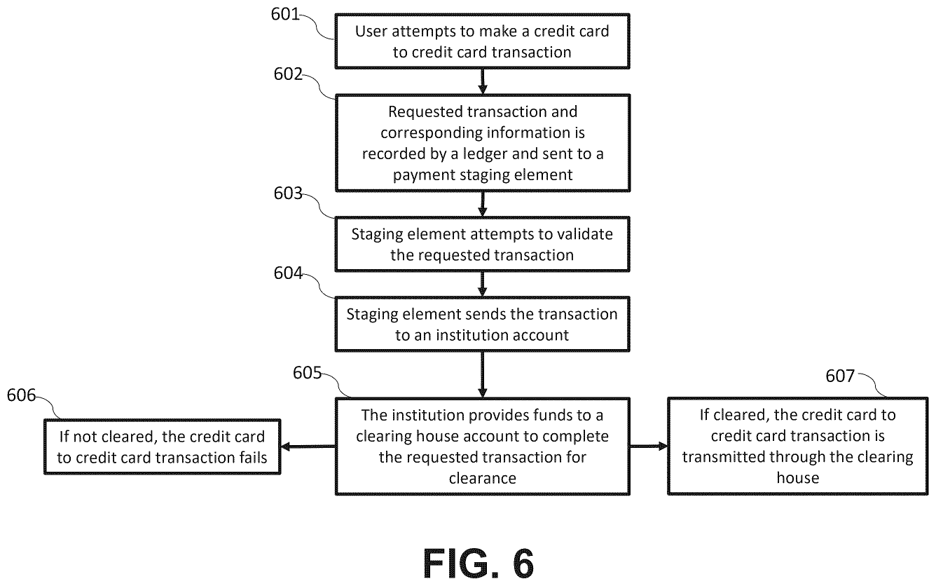

FIG. 6 illustrates an exemplary process for making a credit card to credit card payment. At step 601, a user attempts to make a credit card to credit card payment. For example, the user may interact with an end point device that provides an exemplary GUI consistent with disclosed embodiments to send money from one account that the user manages to another account. Both accounts may be credit accounts. The user may input the necessary information upon selection of a send button consistent with disclosed embodiments.

At step 602, the requested transaction and corresponding information may be recorded and sent to a staging element. For example, after a user selects a send button, consistent with disclosed embodiments, the information that the user input may be sent to a ledger such as a general ledger. The general ledger may also receive corresponding information such as the available balance on the account and the availability of accessible funds, consistent with disclosed embodiments. The ledger may then record the received information. Upon recordation, the requested transaction and corresponding information may then be sent to a staging element.

At step 603, the staging element may attempt to validate the requested transaction, consistent with disclosed embodiments. To validate the transaction, the staging element may attempt to validate the transaction by, for example, reviewing the recorded information from step 602 to ensure the transaction may be completed. For example, the staging element may review information such as the amount attempting to be transferred through the requested transaction and comparing that amount to the available funds in the account. Further, in step 603, the staging element may validate the requested transaction by prompting the user to validate the recorded information. The request by the staging element to the user to validate the transaction may allow the user to review the information before completing the transfer and reduce the risk of fraud or unintended transfers.

The requested transaction may be sent to an institution account in step 604 consistent with disclosed embodiments. Sending the payment to the institution account in step 604 may allow the transfer of funds from one credit card account to another credit card account without the need to have tangible funds. The institution account may be capable of providing the necessary funds for a credit card to credit card transaction based on the validation received from the staging element in step 603.

At step 605, the institution account may provide the requested transaction and corresponding necessary funds to complete the transaction to a clearing house consistent with disclosed embodiments. The clearing house according to step 605 may hold the funds transferred from the institution account until the requested transaction is validated by the staging element. This may mean, for example, that the clearing house account may hold the funds until the institution account that provided the funds for the transaction is reimbursed through the user's account or, alternatively, until the user validates the requested transaction consistent with disclosed embodiments described in step 603. The clearing house may have real time capabilities for fulfilling a transaction consistent with disclosed embodiments. Therefore, step 605 may be completed in a matter of minutes.

If the requested transaction is not cleared in step 605, then at step 606, the requested transaction fails. The requested transaction may fail because, for example, the requested transaction is not successfully validated. For example, if the user receives a request to validate the transaction according to step 603 and the user indicates that the request is not valid, is fraudulent, or is incorrect, then the requested transaction proceed is denied according to step 606.

Alternatively, if the requested transaction is cleared, then the credit card to credit card payment would be transmitted through the clearing house as in step 607. By clearing the transaction, the clearing house sends the funds associated with the requested transaction to the intended recipient of the requested transaction. The requested transaction may be cleared if, for example, the user successfully validates the transaction and sufficient funds are transferred from the user's account to the institution account to reimburse the institution account.

The disclosed embodiments are not limited to the above-described examples, but instead are defined by the appended claims in light of their full scope of equivalents. Moreover, while illustrative embodiments have been described herein, the scope includes any and all embodiments having equivalent elements, modifications, omissions, combinations (e.g., of aspects across various embodiments), adaptations, or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods maybe modified in any manner, including by reordering steps or inserting or deleting steps.

It is intended, therefore, that the specification and examples be considered as example only, with a true scope and spirit being indicated by the following claims and their full scope of equivalents.

What is claimed is:

1. A system comprising:
a memory storing instructions; and
at least one processor configured to execute the stored instructions to control:
a general ledger, the general ledger configured to:
receive a requested transaction from a first account, wherein the first account is a credit account;
receive transaction data associated with the first account and the requested transaction; and
record the transaction data in the general ledger;
a staging element configured to:
receive the requested transaction from the general ledger;
review the transaction data recorded in the general ledger; and
validate the requested transaction based on the transaction data;
an institution account configured to:
receive the requested transaction from the staging element; and
send funds from the institution account to a clearing house based on the requested transaction; and
the clearing house configured to:
receive the funds from the institution account;
receive the transaction data; and
transfer the funds received from the institution account to a second account;
wherein the processor is further configured to:
verify the funds received by the clearing house from the institution account satisfies an amount determined by the requested transaction;
reduce a balance of the first account by the funds transferred from the institution account to the clearing house;
raise a balance of the institution account by the funds transferred from the institution account to the clearing house; and
raise a balance of the second account by the funds received from the clearing house.

2. The system of claim 1, wherein the second account is a credit account.

3. The system of claim 1, wherein the staging element is further configured to request verification data from a user of the first account.

4. The system of claim 3, wherein the general ledger is further configured to record the verification data.

5. The system of claim 1, wherein the system further comprises a real time clearing house, the real time clearing house configured to perform the same actions as the clearing house in real time.

6. The system of claim 5, wherein:
the staging element is further configured to:
determine whether the transaction data should be sent to the clearing house or the real time clearing house; and
the institution account is further configured to:
receive an indication from the staging element, the indication identifying whether the transaction data should be sent to the clearing house or the real time clearing house; and
transfer funds from the institution account to either the clearing house or the real time clearing house based on the indication from the staging element and the transaction data.

7. The system of claim 6, wherein the indication comprises verification data.

8. The system of claim 1, wherein the first account and the second account are managed by the same user.

9. The system of claim 1, wherein the first account and the second account are managed by different users.

10. A system comprising:
a memory storing instructions; and
at least one processor configured to execute the stored instructions to:
access a platform that enables payment initiation;
generate an interface for display on the platform that enables the payment initiation;
analyze, through generative artificial intelligence, a balance limit for an account, an available balance for the account, and user information corresponding to a user associated with the account;
generate a prompt, through generative artificial intelligence, for display on the interface based on the balance limit, the available balance, and the user information, the prompt providing options for managing the account, wherein the options are specific to the user; and
present the prompt on the interface.

11. The system of claim 10, wherein the prompt informs the user associated with the account of a potentially fraudulent transaction based on the user information.

12. The system of claim 11, wherein the prompt further informs the user of actions to take in response to the potentially fraudulent transaction based on the user information.

13. The system of claim 10, wherein the prompt informs the user of an option to request a transaction from a second account, wherein the transaction increases the available balance of the account and reduces an available balance of the second account.

14. The system of claim 13, wherein the user manages the second account.

15. The system of claim 13, wherein the prompt further comprises a notification in the second account regarding a request to complete a transaction from the first account.

16. The system of claim 10, wherein the prompt informs the user to complete a transaction to a second account, wherein the transaction reduces the available balance of the first account and increases an available balance of the second account.

17. A method comprising:
receiving a request from a user to complete a transaction from a first account to a second account, wherein the first account is a credit account;
sending the request and transaction data to a ledger, wherein the ledger records the transaction data;
sending the request from the ledger to a staging element, wherein the staging element reviews the transaction data recorded in the ledger to validate the requested transaction;
sending the request from the staging element to an institution account, wherein the institution account retrieves funds based on the requested transaction;
sending the transaction information and retrieved funds from the institution account to a clearing house;
determining, through the staging element, that the transaction data is cleared; and
transferring the retrieved funds from the clearing house to the second account.

18. The method of claim 17, wherein the staging element determines that the transaction data is not cleared; and
the retrieved funds are returned to the institution account.

19. The method of claim 17, wherein the second account is a credit account.

20. The method of claim 17, wherein the clearing house clears the transaction in real time.
